(19) United States
(12) Patent Application Publication
(10) Pub. No.: US 2008/0149082 A1
(43) Pub. Date: Jun. 26, 2008

(54) Oil Separator

(76) Inventor: Bjorn Heed, Goteborg (SE)

Correspondence Address: SCHWEGMAN, LUNDBERG & WOESSNER, P.A., P.O. BOX 2938, MINNEAPOLIS, MN, 55402, US

(21) Appl. No.: 11/884,637

(22) PCT Filed: Feb. 21, 2006
(86) PCT No.: PCT/SE2006/000226

§ 371 Date: Dec. 18, 2007

(30) Foreign Application Priority Data
Feb. 22, 2005 (SE) 0500403-1

(51) Int. Cl. B01D 45/08

(52) U.S. Cl. 123/573; 55/462

(57) ABSTRACT

A device for separation of oil from the hot gases (5) that are ventilated out from the crank house of a combustion engine. The separation is accomplished by contacting th gases with a cold wall (2) where the oil deposits and is then drained away. The wall (2 is kept cold by the cold gases (4) leaving the device which makes the cooling demand small. The leaving gases (4) are heated by this, so that a higher degree of separation f purification can be accomplished by the use of several similar steps in series.

In internal combustion engines that work with pistons in cylinders there is a certain leakage of gas passing the piston seals out into the crank house. To prevent the gas pressure in the crank house from becoming too high it is therefore necessary to keep this ventilated or open towards the atmosphere or other receiver. The ventilated gases are however heavily polluted by oil aerosol formed by the lubricating oil in the crank house. Thus they carry oil with them. Besides from causing extra oil consumption this also make the gases constitute an environmental problem. Sometimes the latter can be avoided by letting the ventilated gases return to the engine with ingoing combustion air. Sometimes the gases are too polluted for this to be a viable method.

In any case it would be beneficial if one could separate the oil from the gas and return it to the crank house. This would lower the oil consumption and reduce the problems associated with discharge or recirculation of the crank house gases.

The oil however exists in the aerosol in so small droplets that these are difficult to separate out in conventional types of filters or demisters. Filters with sufficient separating capability are prone to clog up. Furthermore the crank house gases are warm so that part of the oil is in the form of vapour and not possible to filter out.

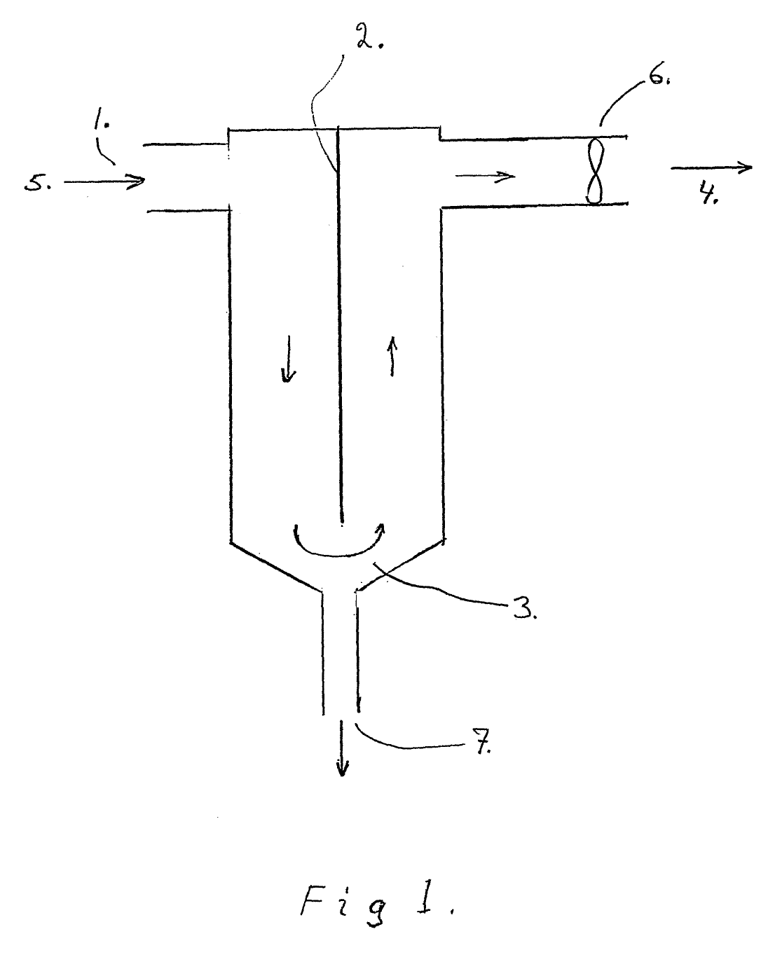

The problems of clogging up and oil in vapour phase can be solved with an oil separator made according to the invention described below. One schematic design is shown in FIG. 1. The gas is entered through an inlet 1 into the upper part of a heat-exchanging device where the gas is cooled as it flows downwards in contact with a wall 2, which on the other side is cooled by the cold gas flow coming from below. This gas flow, coming from below, consists mainly, or at least to a great part, of gas coming from above which is cooled by the addition of cold air in or in the vicinity of the turning chamber 3. With good heat-exchange between downgoing and upgoing gas streams the temperature in the lower part of the device can be made to stay close to the temperature of the added air flow at the same time as the added amount of air is small and the temperature of the outgoing gas flow 4 is close to the temperature of the ingoing gas flow 5. The gases are made to flow through the device by means of the fan 6. Alternatively the flow might be driven by connection to a point of low pressure at the air intake of the engine.

Instead of using the addition of cold air for cooling, this may be achieved by the extraction of heat from the gas by using cooling devices placed in the turning chamber or its vicinity. For instance cooling devices with an internal flow of cooling fluid or cooling fins in contact with a cooler surrounding may be used. With good enough heat exchange between downgoing and upgoing gas flows it might be sufficient that the turning chamber or the lower part of the device is un-insulated towards a cooler surrounding. The heat transfer here can be increased by means of surface area increasing fins applied both at the inside of the wall and possibly its outside. When cooling is accomplished in such an indirect manner and not through the addition of cold air, the fan 6 (or connection to a low pressure) can be dispensed with. A moderate overpressure in the crank house will then make the gases flow through the device.

Oil is deposited on the heat-exchanging wall 2, where it forms an oil film which by gravity is caused to flow downwards and the oil is collected in the turning chamber from which it is drained through an oil outlet 7.

Separation of oil in the device is caused by several different mechanisms:

a) Oil drops are separated from the gas flow when they collide with the walls. Such collisions are promoted by the walls being not smooth but form patterned in such a way that the gas will flow in a turbulent way. This also promotes a good heat exchange between downgoing and upgoing flows.

b) Oil drops are separated from the flow and deposited on the wall by thermal diffusion. Drops situated in a thermal gradient will be caused to move from hot towards the cold by the molecular movements of the gas. This is especially applicable to small droplets and is of significance when droplets in a warm stream of gas are passing along a cold surface.

c) Oil in vapour phase condenses on a cold wall surface.

The critical and difficult step is for the oil to leave the gas stream. Once this is accomplished the oil is caught by and incorporated into a film of oil which is drained downwards towards cooler parts of the device. Oil separation takes place mainly at the downward passage through the device. That is when the thermal diffusion works in the right direction and when the oil in vapour phase condenses on the cold wall.

During its upward passage through the device the gas is heated by contact with a warmer wall. Those droplets that may have escaped from being separated out during the downward flow of the gas can then, at least partly, be vaporized. Oil in vapour phase sometimes constitutes a lesser problem than oil in drop or aerosol form. When having high gas velocities through the device or when wanting a high degree of separation it can be advantageous to apply several separators of the described type in series after one another. Such oil that is vaporized during the heating phase in an earlier step can then condense during the cooling phase of a later step. After several steps entailing cooling and heating the end result can approach a gas stream without oil drops and a concentration of oil vapour that is governed by the vapour pressure of the oil at the lowest temperature.

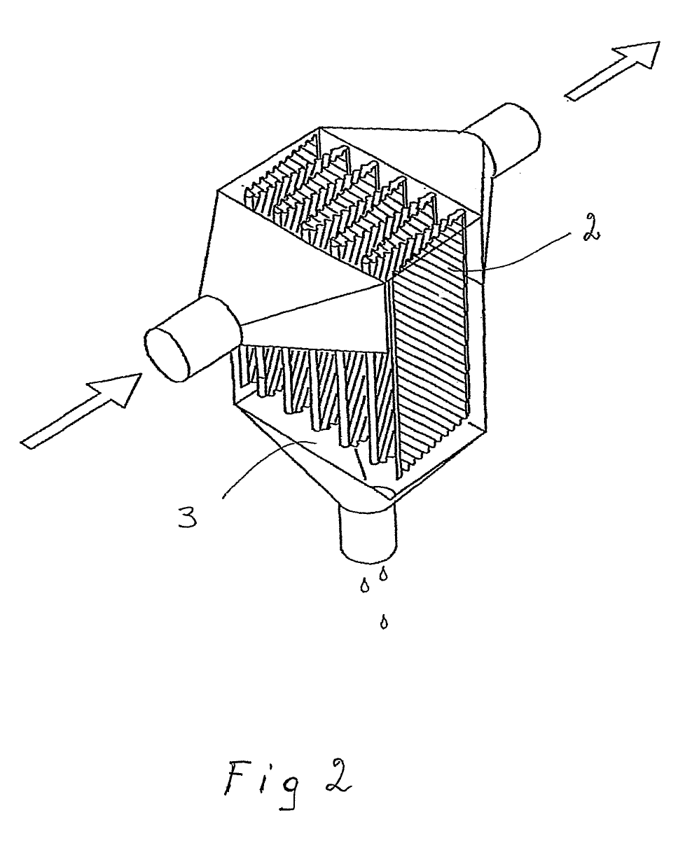

A preferred embodiment of the invention is shown in FIG. 2 where three of the outer walls of the device are removed to show the inner parts of the device. The heat exchanging part 2 is made from a formed foil strip, which is folded into a bundle to create alternating channels for downgoing and upgoing flows undergoing heat exchange with each other. This gives a compact and mechanically stable device with a large heat exchanging surface area within a small volume. At the same time gases can easily be introduced and extracted at the sides of the bundle without a complicated systems for the division of the flows into several parallel channels.

To make the design easier to understand the bundle 2 in FIG. 2 is expanded so making possible to look into the folds. Preferably a compacted bundle is used though. This gives stability and the channels get their intended cross section from the pattern formed in the foil. The bundle that is shown in FIG. 2 has a formed pattern in the shape of an angled corrugation. After folding and compacting of the bundle the corrugations then form a crossing pattern where ridges meet ridges. Thereby a network of channels is created between the foil walls making it possible for the gas to flow forwards in a two-dimensional plane in each fold. The bundle is sealed upwards but open against the turning chamber 3, where the flow goes around the edge of the strip and is transformed from being a downward flow being cooled to become an upward flow being heated.

The two gas flows downwards and upwards gradually change in temperature during their passage through the device. A great advantage is that the heat transfer takes place in counter current flow so that the warmest of the warm flow heats the warmest of the cold flow and that in a corresponding way the coldest of the cold flow cools the coldest of the warm flow. This allows for a high heat exchanging efficiency. The amount of heat that has to be extracted, or the amount of cold air that has to be added in the turning chamber, may then be small and still be able maintain a low temperature in the turning chamber.

In FIG. 1 is described how heat passes through a wall, which separates the two flows. The heat exchange is of so called recuperative type. Alternatively so called regenerative heat exchange can be used. In previously known manner the gases are then made to pass a heat storing body in an alternating way so that this body is alternately heated by the warm flow and cooled by the cold flow. To achieve uninterrupted even gas flows the heat storing body can be made rotating so that one half of it is contacted by warm flow and the other half by cold flow. By the rotation each part of the heat storing body is alternately subject to warm and cold gas flows. It is also possible to use stationary heat exchanging bodies, which are subject to alternating gas flows by means of a valve mechanism. Also in the case of regenerative heat exchange counter current flows are advantageous.

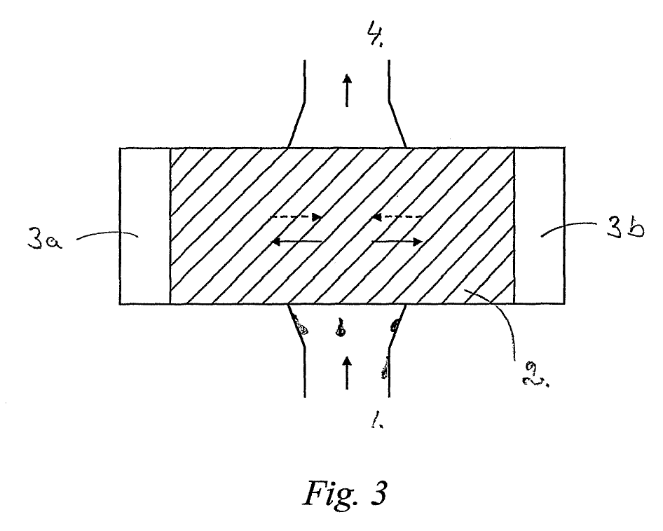

Above, for the sake of simplicity, has been described a device with a warm upper part and a cold lower part to which the oil is drained. Of course it is possible to orient the device in some other direction for instance so that the oil is drained towards the gas inlet of the device and back to the crank house of the engine, even backwards through the same duct that leads the gases from the crank house. In FIG. 3 one such devise is shown where the entering gas at the inlet is divided into two streams that go to two respective different turning chambers (3). Hereby is achieved the advantage of lowering the gas velocity and thereby the pressure drop across the device. The gas is entered through the inlet 1 and during cooling proceeds to one of the two turning chambers 3a or 3b). In the turning chamber the gas changes direction and during heating returns towards the centre of the device and the outlet 4. Heat for the heating process is taken from the gas that flows towards the turning chamber which thereby is being cooled. Oil that is deposited on the heat exchanging surface is first drained downwards and then sideways through the device to finally leave it through the gas inlet 1. The heat exchanging and oil separating surface 2 of the device in FIG. 3 is made as a bundle of form patterned and folded strip similar to the one in FIG. 2 where the design of the bundle is more visible.

It is also possible to dispense with turning chambers and instead divide the gases into two counter current flows that are made to pass through the device. Heat may then be extracted from the middle of the device where the flows change in character from being cooled to being under heated.

1. A device for the separation of oil from crank house ventilation gases from internal combustion engines by cooling of the gases against a cool surface where oil is deposited and the drained away and where the gases enter the device through an inlet port and after oil separation leave the device through an outlet port characterized b y that the device is designed in such a way that the gases going into the device are first cooled by being heat exchanged with the outgoing gases through the cold surface in the form of a separating wall and then are further cooled in a turning chamber before they during their passage through the device are transformed to become outgoing gases.

2. A device for the separation of oil from crank house ventilation gases from internal combustion engines by cooling of the gases against a cool surface where oil is deposited and drained away and where the gases enter the device through an inlet port and after oil separation leave the device through an outlet port characterized by that the device is designed in Such a way that the gases going into the device are first cooled by regenerative heat exchange with outgoing gases and then are further cooled in a turning chamber before they during their passage through the device are transformed to become outgoing gases.

3. A device for the separation of oil from crank house ventilation gases from internal combustion engines according to claim 1, wherein the gases in the turning chamber are cooled by the addition of cold air.

4. A device for the separation of oil from crank house ventilation gases from internal combustion engines according to claim 1, wherein the gases in the turning chamber are cooled by means of cooling devices with an internal flow of cooling fluid.

5. A device for the separation of oil from crank house ventilation gases from internal combustion engines according to claim 1, wherein the gases in the turning chamber are cooled by contact with a wall which on the outside is in contact with a cooler surrounding.

6. A device for the separation of oil from crank house ventilation gases from internal combustion engines according to claim 5 characterized by that the cooling wall is equipped with surface enlarging fins.

7. A device for the separation of oil from crank house ventilation gases from internal combustion engines according to claim 1 characterized by that it is so designed that the gases are divided into two equal streams in counter current orientation which pass the device under heat exchange with one another and that heat is extracted where the gases are midways through.

8. A device for the separation of oil from crank house ventilation gases from internal combustion engines according to claim 1 wherein the heat exchanging wall is made from a pattern formed foil strip which is folded into a bundle creating a set of multiple channels for the gas flows on each side of the foil.

9. (canceled)

10. A device for the separation of oil from crank house ventilation gases from internal combustion engines according to claim 2, wherein the gases in the turning chamber are cooled by the addition of cold air.

11. A device for the separation of oil from crank house ventilation gases from internal combustion engines according to claim 2, wherein the gases in the turning chamber are cooled by means of cooling devices with an internal flow of cooling fluid.

12. A device for the separation of oil from crank house ventilation gases from internal combustion engines according to claim 2, wherein the gases in the turning chamber are cooled by contact with a wall which on the outside is in contact with a cooler surrounding.

13. A device for the separation of oil from crank house ventilation gases from internal combustion engines according to claim 12, wherein the cooling wall is equipped with surface enlarging fins.

14. A device for the separation of oil from crank house ventilation gases from internal combustion engines by cooling of the gases, comprising:
a chamber;
a cooling wall within the chamber to divide the chamber into an inlet portion and an outlet portion;
an inlet in fluid communication with the inlet portion of the chamber, the inlet to receive gas including oil;
an outlet in fluid communication with the outlet portion of the chamber, the outlet to exit gas having a reduced oil content.
wherein the cooling wall is to cool gases going into the inlet portion of the chamber by being heat exchanged with the outgoing gases on another side of the cooling wall;
wherein the chamber includes a turning portion whereat the gases turn from inlet portion to the outlet portion; and
a liquid oil outlet in fluid communication with the chamber.
